(19) United States
(12) Patent Application Publication
(10) Pub. No.: US 2016/0256345 A1
(43) Pub. Date: Sep. 8, 2016

(54) Exercise and Pull Apparatus

(71) Applicant: School of Growth Limited, Hong Kong (HK)

(72) Inventor: Rashit Mullazanov, Hong Kong (HK)

(73) Assignee: School of Growth Limited

(21) Appl. No.: 14/634,900

(22) Filed: Mar. 2, 2015

(51) Int. Cl. A61H 1/02

(52) U.S. Cl. CPC A61H 1/0296

(57) ABSTRACT

The present invention relates to an exercise and pull apparatus comprising: a bottom support on which an upright is arranged; a horizontal frame member arranged at a top region of the upright and provided with a gearbox connected with a clock movement; a bobbin mounted at the horizontal frame member and connected with the gearbox and driven and rotated by the clock movement via the gearbox; a pulling assembly mounted at the bobbin; and a head holder connected therewith for fixation of head. The present invention is relatively safe and reliable as it requires no doors for installation. Since the bobbin is rotated by the clock movement via the gearbox, pulling exercises could be performed with a fine range of pulling magnitude, whereby users could be adapted in a better way for prevention of injuries; and results could be monitored more conveniently and quickly after completion of exercises.

### FIELD OF THE INVENTION

The present invention relates to an exercise apparatus, and particularly to an exercise and pull apparatus.

### DESCRIPTION OF RELATED ART

With the improvement of living standards, there is an increasing demand for home exercise and pull apparatus, as many people would like to do exercises or workouts at home to restore the health of their back or increase their body height; and suitable pull exercises might contribute to correction of improper posture and conducive to health for those people suffering from prolonged improper sitting or standing postures. In addition, appropriate pulling exercises might substantially facilitate the body growth of young people.

Referring to FIG. 1, the head traction means disclosed in U.S. Pat. No. 2,701,564 has to be mounted with a door, such that it is not convenient to use and might pose a hidden danger to health even although it is easy in assembly. Further, the head traction means needs to be incorporated with the door knob and requires manual control by the user for performing the pulling exercises, whereby a single pulling movement of excessive force might cause injury to bone or muscle. In this way, it is most desirable to perform pulling exercises at home in a relatively safe and convenient manner.

### SUMMARY OF THE INVENTION

Features and advantages of the present invention will be at least partially described below, or become obvious from the description hereinafter, or learnt by practicing the present invention.

To overcome the problems of the prior art, the present invention provides an exercise and pull apparatus employing a clock movement configured to drive and rotate a bobbin engaged with a pulling assembly via a gearbox, wherein the pulling assembly is connected to a spreader bar coupled with a headband extended therefrom and used for encompassing the head; whereby controlling the pulling speed and magnitude to avoid causing any injuries to bone or muscle.

The present invention solves the above technical problem by employing technical solutions as follows.

According to one aspect of the invention, there is provided an exercise and pull apparatus comprising: a bottom support on which an upright is arranged; a horizontal frame member arranged at a top region of the upright and provided with a gearbox connected with a clock movement; a bobbin mounted at the horizontal frame member and connected with the gearbox, wherein the bobbin is driven and rotated by the clock movement via the gearbox; a pulling assembly mounted at the bobbin; and a head holder connected with the pulling assembly for fixation of a head.

According to one embodiment of the present invention, wherein the head holder comprises: a spreader bar horizontally disposed and connected with the pulling assembly at its middle portion; and a headband assembly extended from both ends of the spreader bar and used for encompassing the head.

According to another embodiment of the present invention, wherein the headband assembly comprises: two straps respectively drawn out from the ends of the spreader bar; and a pillow having its two ends connected respectively with the two straps.

According to a further embodiment of the present invention, further comprising a ratchet arranged on the spreader bar and connected with the headband assembly.

According to still another embodiment of the present invention, further comprising a rotatable bench being arranged at a lower end of the upright and rotatable therearound.

According to yet still another embodiment of the present invention, further comprising an adjustable screw connected with a top end of the upright; and a top support connected with the adjustable screw.

According to a further embodiment of the present invention, wherein the upright is provided with a scale at its upper half; and the apparatus further comprises a slidably mounted height measurement element arranged at the top region of the upright and located below the horizontal frame member; wherein the height measurement element is rotatable about the upright and movable up and down therealong.

According to another embodiment of the invention, wherein the pulling assembly comprises: a first pulling element having its one end fixed to the bobbin and its other end connected with a turning frame; a carbine hook connected with the turning frame; and a second pulling element having its one end fixed to the carbine hook and its other end connected with a middle portion of the spreader bar.

According to still another embodiment of the invention, wherein the gearbox comprises four gears sequentially meshed with each other.

According to yet still another embodiment of the present invention, further comprising a control and monitor unit positioned right before the head holder for recording exercise results and controlling the clock movement and/or the bobbin.

According to another embodiment of the present invention, further comprising a step motor engaged with the clock movement for adjusting motion thereof.

The exercise and pull apparatus provided by the present invention is stabilized via the bottom support, the upright, and the top support without relying on a door frame or any other auxiliary components, whereby improving safety thereof; and it employs the clock movement configured to drive and rotate the bobbin engaged with the pulling assembly by means of the gearbox, wherein the pulling assembly is connected to the spreader bar coupled with the headband extended therefrom and used for encompassing the head; whereby controlling the pulling speed and magnitude to avoid causing any injuries to bone or muscle.

Features and details of those technical solutions will be better understood by those skilled in the art from the following detailed description and the drawings accompanied therewith.

### BRIEF DESCRIPTION OF THE DRAWINGS

The advantages and implementation manners of the present invention will become more apparent by reference to the following detailed description when taken in conjunction with the accompanying drawings, wherein the content shown in the drawings is provided merely for explanation of the present invention and shall not be construed as limiting in any way the present invention.

FIG. 1 is a schematic structural view of a head traction means of the prior art.

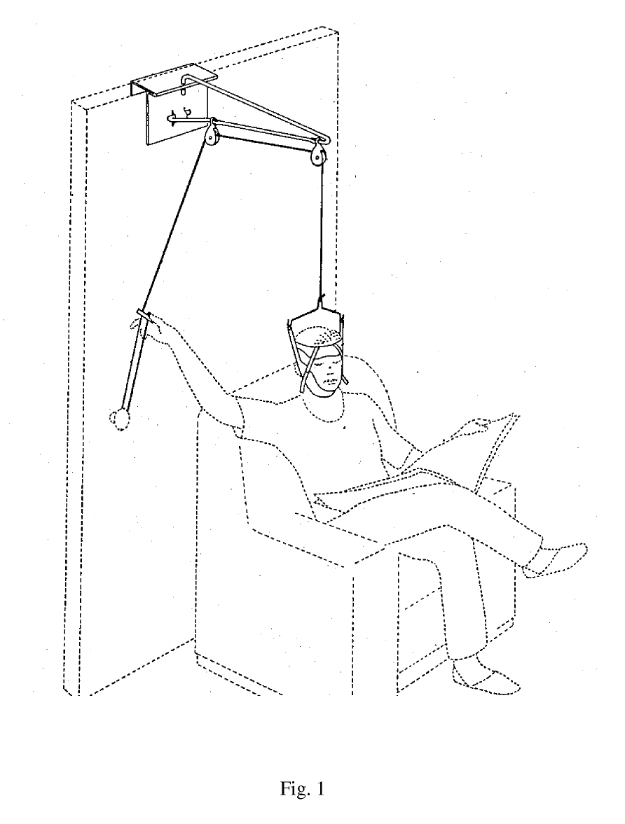

FIG. 2 is a schematic structural view of the exercise and pull apparatus of an embodiment of the present invention.

FIG. 3 is a schematic view of the internal structure of the horizontal frame member of an embodiment of the present invention.

FIG. 4 is a schematic view of the internal structure of the gearbox of an embodiment of the present invention.

FIG. 5 is a schematic structural view of the pulling assembly of an embodiment of the present invention.

FIG. 6A is a schematic view of the exercise and pull apparatus ready for use according to one embodiment of the present invention.

FIG. 6B is a schematic view of the exercise and pull apparatus in use according to one embodiment of the present invention.

FIG. 6C is a schematic view of the exercise and pull apparatus used for taking measurement after exercise according to one embodiment of the present invention.

### DETAILED DESCRIPTION OF PREFERRED EMBODIMENTS

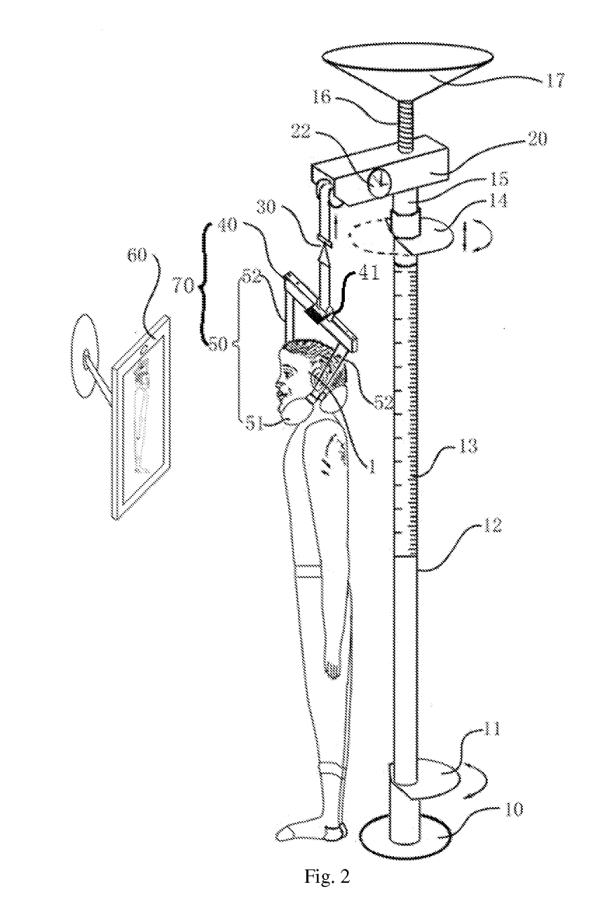

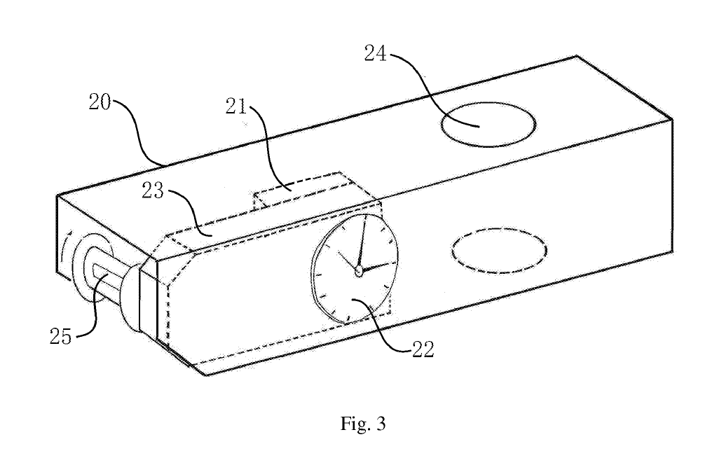

As shown in FIGS. 2 and 3, the present invention provides an exercise and pull apparatus comprising: a bottom support 10 on which an upright 12 is arranged; a horizontal frame member 20 arranged at a top region 15 of the upright and provided with a gearbox 23 connected with a clock movement 21; a bobbin 25 mounted at the horizontal frame member 20 and connected with the gearbox 23, wherein the bobbin 25 is driven and rotated by the clock movement 21 via the gearbox 23; a pulling assembly 30 mounted at the bobbin 25; and a head holder 70 connected with the pulling assembly 30 for fixation of the head of a user. In order to facilitate the use of the head holder 70 by the user, it further comprises: a rotatable bench 11 being arranged at a lower end of the upright 12 and rotatable there around. In this way, the user could stand on the rotatable bench 11 and mount the head holder 70 at the head in a relatively comfortable manner, and afterwards, the rotatable bench 11 could be further rotated to allow feet of the user to be hung up in the air or stood on the ground. In addition, a clock face 22 could be also arranged at an outer surface of the horizontal frame member 20, and the clock face 22 is connected to the clock movement 21 through the gearbox 23 to enable not only the timing feature but also the predication of the number of rotations of the bobbin 25, whereby determining the traction magnitude thereof.

The upper half of the upright 12 is provided with a scale 13 of which the finest markings might represent increments of one millimeter/inch or less. In the present embodiment, millimeter and/or inch markings are marked on different regions of the upper half of the upright 12, and the scale 13 is further accompanied with a slidably mounted height measurement element 14 arranged at the top region of the upright 12 and located below the horizontal frame member 20; wherein the height measurement element 14 is configured to be rotatable about the upright 12 and movable up and down therealong. In this regard, the traction data could be measured directly after each of workouts in a very convenient manner. The height measurement element 14 might be in the form of a fan-shaped arrangement, and likewisely, the rotatable bench 11 might be of a fan-shaped structure.

The top end of the upright 12 might be directly inserted into the ceiling and fixed thereto, or the top end of the upright 12 could be provided with an adjustable screw 16 above which a top support 17 is connected, wherein the top support 17 is of an inverted conical form and in contact with the ceiling. Moreover, according to a specific embodiment of the present invention, the top region 15 of the upright 12 could be separated from the rest of the upright and formed separately as an extension portion, and here, the horizontal frame member 20 might be connected with the extension portion.

In the present embodiment, the head holder 70 comprises a spreader bar 40 horizontally disposed and connected with the pulling assembly 30 at its middle portion; and a head harness or headband assembly 50 extended from both ends of the spreader bar 40 and used for encompassing the head 1. It might further comprise a ratchet 41 arranged on the spreader bar 40 and connected with the headband assembly 50.

The head harness or headband assembly 50 comprises: two straps 52 respectively drawn out from the ends of the spreader bar 40, and in particular, one strap 52 is drawn out from one end of the spreader bar 40, and the other strap 52 is drawn out from the other end of the spreader bar 40, such that both ends of straps 52 are located on respective ends of the spreader bar 40 and in the form of a ring; and a pillow 51 having its two ends connected respectively with the two straps, wherein the headband assembly might comprise two pillows 51 mounted respectively at connection points between the chin and the rear part of the cranium and the neck. In addition, two ends of the same strap 52 could be located at respective ends of the spreader bar 40, in which case each of the cushions 51 is disposed in the middle portion of respective straps 52. In order to prevent the rotation of the headband, the ratchet 41 is arranged on the spreader bar 40 and connected with the headband assembly 50, and more particularly, the ratchet 41 is connected with the straps 52, such that the headband assembly 50 could be adjusted to provide a more comfortable fit for the user before using the exercise and pull apparatus.

In the present embodiment, it further comprises a control and monitor unit 60 at which an internal or external camera or video capturing device is arranged, wherein the control and monitor unit might be a computer, a smart phone, a tablet computer, a notebook/netbook, an iPad, or the like. The control and monitor unit 60 might be mounted on the wall or mounted at an arm portion preferably integrated with and extended from the horizontal frame member 20 (not shown) to enable the control and monitor unit to be positioned or located right before the headband and oriented to the head of the user to facilitate the self-monitoring of user's exercise while performing exercises or workouts. Moreover, the control and monitor unit 60 might also enable an automatic measurement of height data and recordation of results of exercise via the camera or video capturing device and a software module run on the processor of the control and monitor unit 60.

The exercise and pull apparatus further comprises: a step motor 21, which could be arranged separately or engaged with the clock movement 21 in such a manner which could be adapted for adjusting independently or cooperatively the motion of the clock movement 21 and/or the bobbin 25; and the step motor could be coupled with and controlled by the control and monitor unit 60, whereby adjusting the speed of the bobbin 25 and the timing thereof.

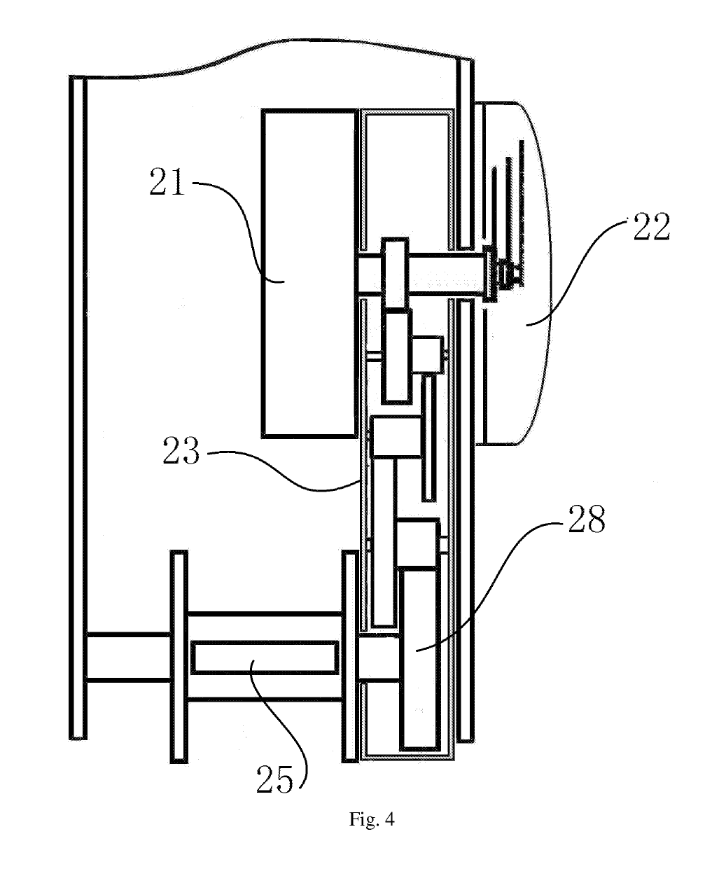

Referring to both FIGS. 3 and 4, in the present embodiment the horizontal frame member 20 has a rectangular shape, on which a through hole is arranged for passing through of the upright 24, wherein the clock face is arranged at a lateral surface of the horizontal frame member 20, and the bobbin 25 is arranged at another lateral surface with which one end of the gearbox 23 is in contact; and the gearbox 23 comprises four gears 28 sequentially meshed with each other, wherein one of the gears at the front end is coupled with the clock movement 21 and the other one of the gears at the rear end is coupled with the bobbin 25. Thusly, the bobbin 25 is driven and rotated by the clock movement 21 via the gearbox 23.

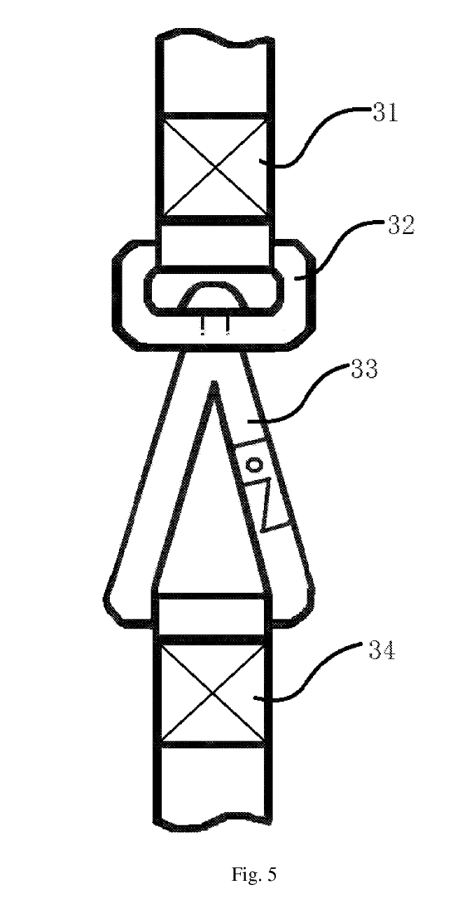

As shown in FIG. 5, the pulling assembly 30 comprises: a first pulling element 31 having its one end fixed to the bobbin 25 and its other end connected with a turning frame 32; a carbine hook 33 connected with the turning frame 32; and a second pulling element 34 having its one end fixed to the carbine hook 33 and its other end connected with a middle portion of the spreader bar 40. The pulling assembly 30 might adjust adaptively the angle of the headband to match with different users, and in addition, the bobbin 25 could also be used to change the overall length of the pulling assembly 30 to adapt to users of different height.

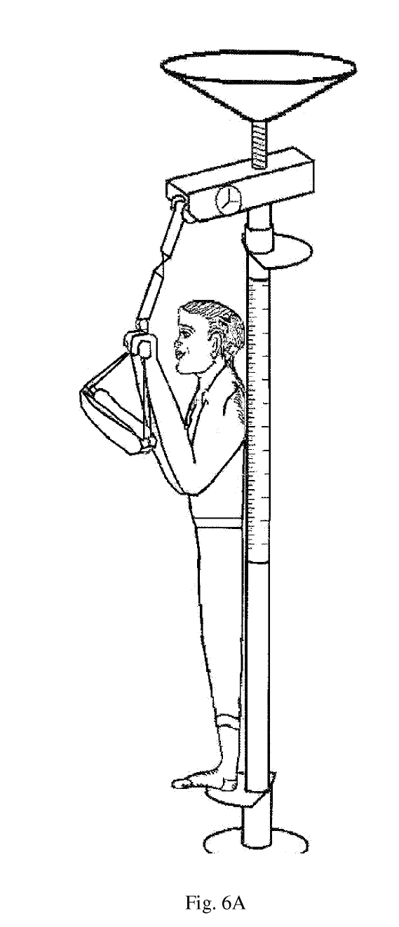

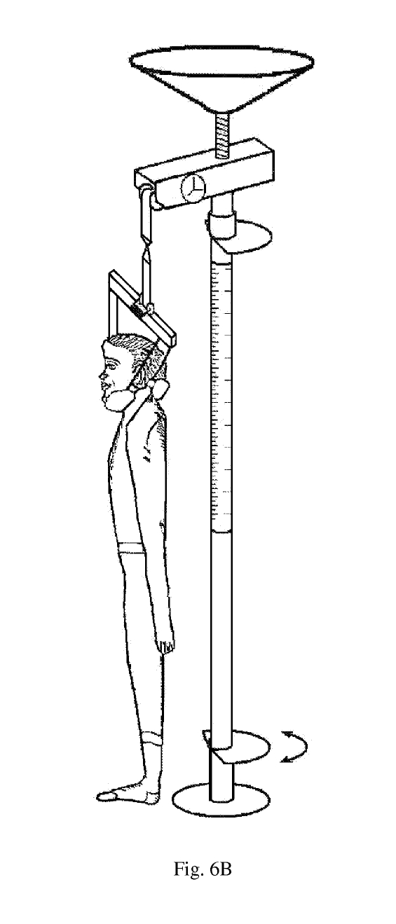

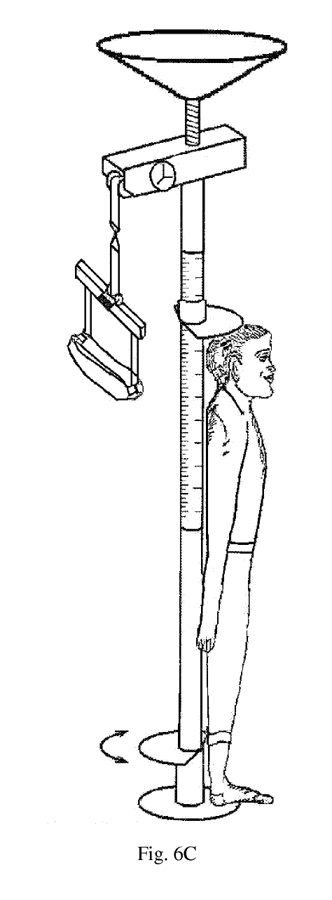

Referring to FIGS. 6A-6C, when a user is ready to use the exercise and pull apparatus of the present invention, the user could stand on the rotatable bench 11, and hold the spreader bar 40 with hands to adjust the angle of the headband and hitch the headband over the head. Afterwards, the rotatable bench 11 could be further rotated to allow feet of the user to be hung up in the air or stood on the ground, and let the headband and thus the head/body of the user be lifted and pulled upwardly via the rotation of the bobbin 25. After completion of the workout, the user could use directly the scale on the upright for taking the traction data. It should be noted that the employment of the exercise and pull apparatus of the present invention enables a very small lifting amount/increment to the body/height of the user in a daily basis, the daily increment is less than 1 mm, and might range from about 1/80- 1/100 of inch, i.e., the final overall annual traction amount or lifting amount might be about 4 inches (or 10 cm), and such a small daily increment might be relatively easily adapted by the user.

The exercise and pull apparatus provided by the present invention is relatively safe and reliable as it requires no doors for installation. Since the bobbin is rotated by the clock movement via the gearbox, pulling exercises could be performed with a fine range of pulling magnitude, whereby users could be adapted in a better way for prevention of injuries; and the provision of the scale and the height measurement element on the upright enable the results to be monitored more conveniently and quickly after completion of each exercise; and the provision of the control and monitor unit facilitates user' s self-monitoring during exercises or workouts and also enables an automatic recordation of the results thereof.

The preferred embodiments of the present invention have been described above in details with reference to the accompanied drawings, though it will be apparent to those skilled in the art that a variety of modifications and improvements could be made without departing from the scope and substance of the present invention. For example, a feature illustrated or described as a part of one embodiment might be used in another embodiment to yield a further embodiment. The above are merely some preferred embodiments of the present invention and serve as no limitation to the scope of the present invention, and those equivalent alterations by making use of the contents of the above description and accompanied drawings shall all fall into the protection scope of the present invention.

What is claimed is:

1. An exercise and pull apparatus comprising:
a bottom support on which an upright is arranged;
a horizontal frame member arranged at a top region of the upright and provided with a gearbox connected with a clock movement;
a bobbin mounted at the horizontal frame member and connected with the gearbox, wherein the bobbin is driven and rotated by the clock movement via the gearbox;
a pulling assembly mounted at the bobbin; and
a head holder connected with the pulling assembly for fixation of a head.

2. An exercise and pull apparatus according to claim 1, wherein the head holder comprises: a spreader bar horizontally disposed and connected with the pulling assembly at its middle portion; and a headband assembly extended from both ends of the spreader bar and used for encompassing the head.

3. An exercise and pull apparatus according to claim 2, wherein the headband assembly comprises: two straps respectively drawn out from the ends of the spreader bar; and a pillow having its two ends connected respectively with the two straps.

4. An exercise and pull apparatus according to claim 2, further comprising a ratchet arranged on the spreader bar and connected with the headband assembly.

5. An exercise and pull apparatus according to claim 1, further comprising a rotatable bench being arranged at a lower end of the upright and rotatable therearound.

6. An exercise and pull apparatus according to claim 1, further comprising an adjustable screw connected with a top end of the upright; and a top support connected with the adjustable screw.

7. An exercise and pull apparatus according to claim 1, wherein the upright is provided with a scale at its upper half; and the apparatus further comprises a height measurement element arranged at the top region of the upright and located below the horizontal frame member; wherein the height measurement element is rotatable about the upright and movable up and down therealong.

8. An exercise and pull apparatus according to claim 1, wherein the pulling assembly comprises: a first pulling element having its one end fixed to the bobbin and its other end connected with a turning frame; a carbine hook connected with the turning frame; and a second pulling element having its one end fixed to the carbine hook and its other end connected with a middle portion of the spreader bar.

9. An exercise and pull apparatus according to claim 1, further comprising a control and monitor unit positioned right before the head holder for recording exercise results and controlling the clock movement and/or the bobbin.

10. An exercise and pull apparatus according to claim 1, further comprising a step motor arranged separately or engaged with the clock movement for adjusting motion thereof.
